(19) United States
(12) Patent Application Publication
(10) Pub. No.: US 2019/0061804 A1
(43) Pub. Date: Feb. 28, 2019

(54) DE-LASH ASSEMBLY FOR MANUALLY ADJUSTABLE STEERING COLUMN

(71) Applicant: STEERING SOLUTIONS IP HOLDING CORPORATION, Saginaw, MI (US)

(72) Inventors: Robert C. Derocher, Essexville, MI (US); Leslie E. Edmundson, Clio, MI (US)

(21) Appl. No.: 15/683,197

(22) Filed: Aug. 22, 2017

(51) Int. Cl. B62D 1/183; B62D 1/184; B62D 1/189

(52) U.S. Cl. CPC B62D 1/183; B62D 1/189; B62D 1/184

(57) ABSTRACT

A steering column assembly includes a first jacket. Also included is a second jacket operatively coupled to the first jacket, the first jacket manually telescopingly moveable relative to the second jacket between an extended position and a retracted position. Further included is a de-lash assembly that includes at least one bearing in contact with an outer surface of the first jacket. The de-lash assembly also includes an adjustment component assembly operatively coupled to the at least one bearing to adjust a load applied on the outer surface of the first jacket by the bearing.

### BACKGROUND

The following description relates to steering column assemblies and, more particularly, to a power adjustable column with a manual unstow function for autonomous or semi-autonomous vehicles.

Adjustable steering column assemblies are limited to a range of motion that keeps the steering wheel within proximity of the driver's reach. However, advancements in autonomous or semi-autonomous driving systems may eliminate this limitation in some cases. If a steering wheel is retracted away from a driver to a retracted (e.g., stowed) position, it may be desirable to maintain the column in the retracted position, while allowing for a driver to quickly and easily reposition the steering wheel to an extended position.

Steering column assemblies often require the application of force and de-lashing a power telescope steering jacket to increase natural frequency and stiffness. This may be done with a spring loaded bushing. The loading between the telescoping column jackets improves some functional requirements of the column, but creates excessive friction between the interface of the bushing and the telescoping jacket. This friction, when applied to steering columns that require or allow manual un-stowing of the column assembly creates loads that are too high for most users.

### SUMMARY OF THE INVENTION

According to one aspect of the disclosure, a steering column assembly includes a first jacket. Also included is a second jacket operatively coupled to the first jacket, the first jacket manually telescopingly moveable relative to the second jacket between an extended position and a retracted position. Further included is a de-lash assembly that includes at least one bearing in contact with an outer surface of the first jacket. The de-lash assembly also includes an adjustment component assembly operatively coupled to the at least one bearing to adjust a load applied on the outer surface of the first jacket by the bearing.

According to another aspect of the disclosure, a steering column assembly for an autonomous or semi-autonomous vehicle includes a first jacket having an outer surface. Also included is a second jacket operatively coupled to the first jacket, the first jacket manually telescopingly moveable relative to the second jacket between an extended position and a retracted position, the second jacket defining a plurality of bores with a plurality of bore walls. Further included is a plurality of de-lash assemblies located at least partially within the bores of the second jacket, each of the plurality of de-lash assemblies including a bearing housing defining a pair of recesses and disposed within the bore of the second jacket. Each of the de-lash assemblies also include a pair of bearings in contact with the outer surface of the first jacket, each of the bearings disposed within one of the recesses of the bearing housing. Each of the de-lash assemblies further include a pair of retaining pins extending through apertures of the bearing housing, each of the retaining pins extending through a respective aperture of the bearing housing and through a central aperture one of the pair of bearings. Each of the de-lash assemblies yet further include an adjustment cup in operative contact with the bearing housing and adjustable to adjust a load applied on the outer surface of the first jacket by the bearings. Each of the de-lash assemblies also include a spring disposed between the adjustment cup and the bearing housing.

These and other advantages and features will become more apparent from the following description taken in conjunction with the drawings.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a perspective view of a portion of a steering column assembly with a de-lash assembly, the de-lash assembly in a disassembled condition; and

FIG. 2 is a cross-sectional view of the de-lash assembly.

### DETAILED DESCRIPTION

Referring now to the Figures, where the invention will be described with reference to specific embodiments, without limiting same, a steering column assembly with manual stowing capability is disclosed. The embodiments described herein may be employed with various types of steering columns. In particular, electric power steering systems and autonomous or semi-autonomous driving systems are examples of vehicle steering columns that may benefit from the embodiments disclosed herein. The term autonomous or semi-autonomous refers to vehicles or vehicle sub-systems that are configured to perform operations without continuous input from a driver (e.g., steering, accelerating, braking etc.) and may be equipped with Advanced Driver Assist Steering (ADAS) system(s) to allow the vehicle to be autonomously controlled using sensing, steering, and/or braking technology.

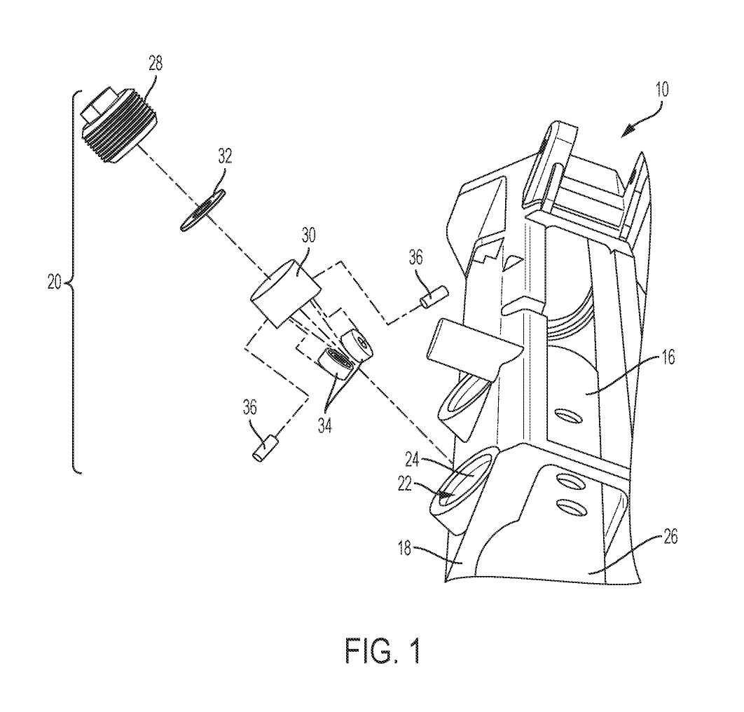

Referring to FIG. 1, the steering column assembly 10 is illustrated. The steering column assembly includes a steering shaft (not shown) that is disposed within a first jacket 16, which may be referred to as an upper jacket. The upper jacket 16 is in telescoping connection with a second jacket 18, which may be referred to as a lower jacket. The telescoping arrangement of the jackets 16, 18 allows the column assembly, and therefore, the steering wheel, to be translated to provide adjustment capability of the steering wheel relative to a seated driver. Typically, the steering column assembly 10 is adjustable over a first range of movement that is limited to a range of positions that allow a driver to comfortably reach and handle the steering wheel for manual steering of the vehicle in a manual driving mode. This first retraction limit is a typical telescope retraction limit provided by steering column assemblies. However, the steering column assembly 10 disclosed herein may be utilized in an autonomous or semi-autonomous vehicle, as described above. In such embodiments, the steering column assembly 10 may be retracted away from the driver and toward or into the instrument panel of the vehicle to a range of positions that are out of the typical range of manual steering positions. This additional range of movement is referred to as a second range of movement of the steering column assembly 10.

The first range of movement, or positions, define an extended position of the steering column assembly 10 and the second range of movement, or positions, define a retracted (or stowed) position. The extended position is employed when the vehicle is in a manual steering, or driving, mode and the retracted position is available when the vehicle is in the autonomous or semi-autonomous driving mode. The retracted position provides more room for a driver, thereby providing enhanced comfort or functionality. In the embodiments described herein, the steering column assembly 10 is manually retractable, such that the driver may manually exert a force towards oneself on the steering column assembly 10 to translate the upper jacket 16, relative to the lower jacket 18. This may be done within the first and/or second ranges of movement, as defined above.

As shown in a disassembled view of FIG. 1, a de-lash assembly 20 is provided as part of the steering column assembly 10. The de-lash assembly 20 includes a plurality of components that are at least partially disposed within a bore 22 defined by a bore wall 24 of the lower jacket 18. The lower jacket 18 includes two bores 22 in the illustrated embodiment, but it is to be appreciated that less or more bores 22 may be provided. The bore 22 provides a space to at least partially contain the de-lash assembly 20 and provides access for contact between the de-lash assembly 20 and an outer surface 26 of the upper jacket 16. The contact between the de-lash assembly 20 and the outer surface 26 facilitates the application of a force on the upper jacket 16 to increase natural frequency and stiffness of the steering column assembly 10.

The de-lash assembly 20 includes an adjustment cup 28, a bearing housing 30, a spring 32, at least one bearing 34 and at least one retaining pin 36. These components are described in detail herein.

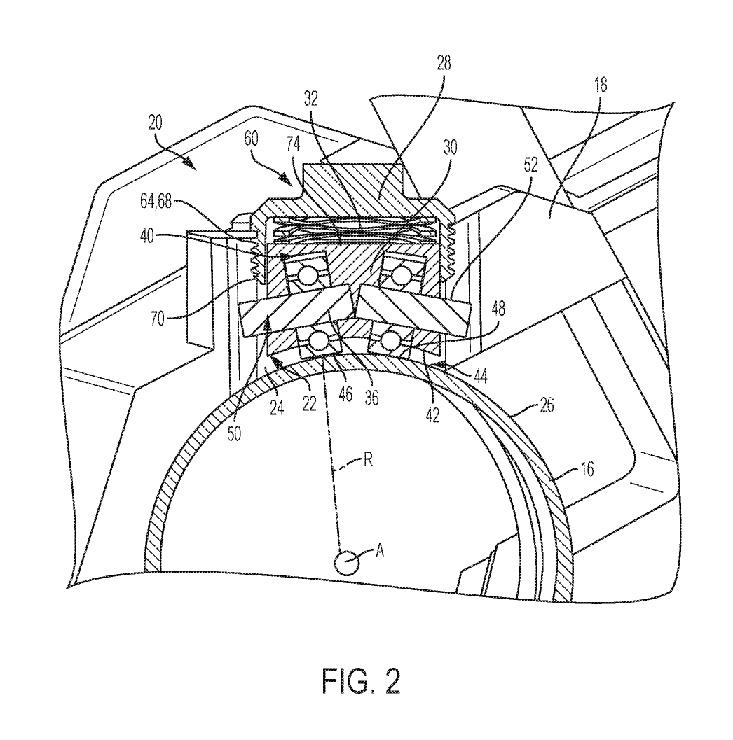

Referring now to FIG. 2, a sectional view of the steering column assembly 10 illustrates the de-lash assembly 20 in more detail and in an assembled condition. As described above, the overall steering column assembly 10 may include a plurality of de-lash assemblies located at different axial and/or circumferential positions along the steering column assembly 10. For purposes of discussion, a single de-lash assembly 20 is described in detail herein.

As noted above, it is contemplated that a single bearing is provided. However, in some embodiments a plurality of bearings, such as the illustrated pair of bearings 34 is included. Each of the pair of bearings 34 are located within a recess 40 defined by the bearing housing 30. In particular, the recesses 40 extend from a first end 42 of the bearing housing 30. The first end 42 is arcuate to accommodate the curvature of the upper jacket 16, but typically there is a clearance 44 between the first end 42 and the outer surface 26 of the upper jacket 16. The bearings 34 and the depth of the recesses 40 are dimensioned to have a portion of the bearings 34 protrude from the recesses 40, with a rolling surface 46 in contact with a contact surface 48 of the outer surface 26 of the upper jacket 16. The contact surface 48 is a smooth surface that does not require races for desired operation of the bearings 34.

The bearings 34 are oriented at a non-parallel angle relative to each other, as shown in the illustrated embodiment. In particular, the rolling surface 46 of the bearings 34 are oriented substantially perpendicular to a radial line R extending from an axial centerline A of the upper jacket 16 to the contact surface 48. This ensures a consistent load applied to the upper jacket 16 during translation of the upper jacket 16 relative to the lower jacket 18 and smooth rolling engagement between the bearings 34 and the upper jacket 16.

The bearings 34 are retained within the recesses 40 with the pair of retaining pins 36. The retaining pins 36 extend through respective apertures defined by the bearing housing 30. In particular, each of the retaining pins 36 extend through a side wall 48 of the bearing housing 30 and through a central aperture of a respective bearing. The retaining pins 36 have an end portion 50 seated within a respective cavity 52 defined by the bore wall 24 to fix the position of the retaining pins 36 and provide additional rigidity of the de-lash assembly 10 within the bore 22. In some embodiments, it is contemplated that friction or an alternate coupling arrangement between the retaining pins 36 and the bore wall 24 sufficiently retains the retaining pins 36.

To adjust the load applied on the upper jacket 16 with the de-lash assembly 20 generally, and the bearings 34 specifically, an adjustment component assembly 60 is operatively coupled to the bearings 34. The adjustment component assembly 60 includes the adjustment cup 28 that is substantially cylindrical. The adjustment cup 28 includes an outer surface 64 having a threaded pattern 68 thereon. The threaded pattern 68 is threadingly engageable with a threaded portion 70 of the bore wall 24. As shown, the adjustment cup 28 defines a hollow interior that surrounds a portion of the bearing housing 30. A resilient element, such as a spring 32 is sandwiched between the adjustment cup 28 and a second end 74 of the bearing housing 30. The spring 32 may be various types of springs, such as a stacked wave spring or a disc spring, for example.

In operation, as the adjustment cup 28 is rotated to adjust the position of the adjustment cup 28 within the bore 22, the load applied on the upper jacket 16 is adjusted. The use of bearings 34 facilitate load adjustment, but provides a rolling element to reduce manual stow/un-stow effort by a driver manually translating the steering column assembly 10.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description.

Having thus described the invention, it is claimed:

1. A steering column assembly comprising:
a first jacket;
a second jacket operatively coupled to the first jacket, the first jacket manually telescopingly moveable relative to the second jacket between an extended position and a retracted position; and
a de-lash assembly comprising:
at least one bearing in contact with an outer surface of the first jacket; and
an adjustment component assembly operatively coupled to the at least one bearing to adjust a load applied on the outer surface of the first jacket by the bearing.

2. The steering column assembly of claim 1, wherein the at least one bearing is one of a pair of bearings, each of the bearings at least partially disposed within a respective recess of a bearing housing disposed within a bore defined by a bore wall of the second jacket.

3. The steering column assembly of claim 2, wherein the pair of bearings are positioned in a non-parallel orientation relative to each other.

4. The steering column assembly of claim 3, wherein each of the pair of bearings include a rolling surface in contact with a respective contact location of the outer surface of the first jacket, the contact locations being perpendicular to a radial line extending between an axial centerline of the first jacket and the outer surface of the first jacket.

5. The steering column assembly of claim 2, further comprising a pair of retaining pins extending through apertures of the bearing housing, each of the retaining pins extending through a respective aperture of the bearing housing and through a central aperture one of the pair of bearings.

6. The steering column assembly of claim 5, wherein each of the retaining pins have an end portion disposed within a respective cavity defined by the bore wall.

7. The steering column assembly of claim 2, wherein the at least one adjustment component assembly comprises an adjustment cup and a spring, the spring disposed between the adjustment cup and the bearing housing.

8. The steering column assembly of claim 7, wherein the spring is a stacked wave spring.

9. The steering column assembly of claim 7, wherein the spring is a disc spring.

10. The steering column assembly of claim 7, wherein the adjustment cup includes a thread pattern on an outer surface of the adjustment cup, the adjustment cup threadedly engageable with the bore wall.

11. The steering column assembly of claim 1, wherein the outer surface of the first jacket is a smooth surface defining a constant outer diameter.

12. The steering column assembly of claim 1, wherein the steering column assembly is for an autonomous driving assist steering (ADAS) system.

13. A steering column assembly for an autonomous or semi-autonomous vehicle comprising:
a first jacket having an outer surface;
a second jacket operatively coupled to the first jacket, the first jacket manually telescopingly moveable relative to the second jacket between an extended position and a retracted position, the second jacket defining a plurality of bores with a plurality of bore walls; and
a plurality of de-lash assemblies located at least partially within the bores of the second jacket, each of the plurality of de-lash assemblies comprising:
a bearing housing defining a pair of recesses and disposed within the bore of the second jacket;
a pair of bearings in contact with the outer surface of the first jacket, each of the bearings disposed within one of the recesses of the bearing housing;
a pair of retaining pins extending through apertures of the bearing housing, each of the retaining pins extending through a respective aperture of the bearing housing and through a central aperture one of the pair of bearings;
an adjustment cup in operative contact with the bearing housing and adjustable to adjust a load applied on the outer surface of the first jacket by the bearings; and
a spring disposed between the adjustment cup and the bearing housing.

14. The steering column assembly of claim 13, wherein the pair of bearings are positioned in a non-parallel orientation relative to each other.

15. The steering column assembly of claim 14, wherein each of the pair of bearings include a rolling surface in contact with a respective contact location of the outer surface of the first jacket, the contact locations being perpendicular to a radial line extending between an axial centerline of the first jacket and the outer surface of the first jacket.

16. The steering column assembly of claim 13, wherein each of the retaining pins have an end portion disposed within a respective cavity defined by the bore wall.

17. The steering column assembly of claim 13, wherein the spring is a stacked wave spring.

18. The steering column assembly of claim 13, wherein the spring is a disc spring.

19. The steering column assembly of claim 13, wherein the outer surface of the first jacket is a smooth surface defining a constant outer diameter.
